(19) United States
(12) Patent Application Publication
(10) Pub. No.: US 2025/0307391 A1
(43) Pub. Date: Oct. 2, 2025

(54) Intelligent security for data fabrics

(71) Applicant: Realm.Security, Inc., Wellesley, MA (US)

(72) Inventors: Jeffrey Kraemer, Wellesley, MA (US); Sanket Choksey, Wellesley, MA (US)

(21) Appl. No.: 19/091,454

(22) Filed: Mar. 26, 2025

Related U.S. Application Data
(60) Provisional application No. 63/569,765, filed on Mar. 26, 2024.

(51) Int. Cl. G06F 21/55

(52) U.S. Cl. CPC G06F 21/554; G06F 2221/034

(57) ABSTRACT

Methods and apparatus for processing security events within a data fabric. Information comprising a security event is received and augmented by applying information from at least one organizational data source. At least one action is taken based on the augmented data.

### CROSS REFERENCE TO RELATED APPLICATIONS

The present application claims the benefit of and priority to U.S. provisional application No. 63/569,765, filed on Mar. 26, 2024, the content of which is hereby incorporated by reference as if set forth in its entirety herein.

### TECHNICAL FIELD

The following disclosure is directed to cybersecurity. In particular, the present disclosure is directed to apparatuses and methods for cybersecurity event logs and alerts.

Embodiments described herein generally relate to systems and methods for computer security and, more particularly but not exclusively, to systems and methods for processing computer security events using organizational knowledge.

### BACKGROUND

Businesses are faced with a security information problem. Companies are deploying an ever-increasing number of security tools to address the cyberthreat landscape. Depending upon company size, the number of deployed security products typically ranges from 15 to 75. In addition to the complexity of collecting and managing the security related events and alerts generated by both these tools as well as business applications, companies are seeing an exponential growth in the volume of security data and its associated costs.

This trend led to development of the “Data Fabric” as a technology and commercial category of product. A data pipeline is a method of ingesting raw data from various sources (e.g., firewalls, endpoints and EDR products, Identity Providers, data lakes, etc.), transforming it (e.g. enriching, filtering, reducing, redacting, masking, reformatting, etc.), and forwarding it to a specific destination, such as a security information and event management (SIEM) device or a data lake. A data fabric integrates various data pipelines and cloud environments.

A data fabric has the potential to help companies reduce cost by reducing the volume of unnecessary data being sent to various destinations. Unfortunately, this potential relies upon a user's understanding of what data within their own unique environment can be ignored. This in turn presents a new challenge with currently inadequate solutions.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments of the present invention relate to an apparatus for processing security events within a data fabric. The apparatus includes a processor and a memory communicatively coupled to the processor. The memory contains instructions configuring the processor to receive information from at least one organizational data source; receive data comprising a security event; augment the received data by applying the received information to the received data; and take at least one action based on the augmented data.

In some embodiments the received information is non-security information.

In some embodiments the at least one action is generating an alert of a potential security threat based on the augmented data.

In some embodiments the processor is further configured to derive at least one rule from the received information and applying the received information includes applying the at least one derived rule to the received data, and the at least one action is prescribed by the at least one derived rule. In some embodiments the processor is further configured to receive input enabling or disabling the at least one derived rule. In some embodiments the processor is further configured to evaluate the at least one derived rule to identify potential collisions with important events and reconcile the collisions to create an improved rule.

In some embodiments augmenting the received data includes associating the received data with at least one category. In some embodiments the at least one action is routing the augmented data based on the at least one category.

In some embodiments the at least one action is storing the augmented data for later review.

In some embodiments the at least one action is retrieving historical security events from a data storage system and forwarding the retrieved events to facilitate further investigation.

In another aspect, embodiments of the present invention relate to a method of processing security events within a data fabric using a computing device. The method includes receiving information at the computing device from at least one organizational data source; receiving data comprising a security event at the computing device; augmenting, by the computing device, the received data by applying the received information to the received data; and taking at least one action based on the augmented data using the computing device.

In some embodiments the received information is non-security information.

In some embodiments the at least one action is generating an alert of a potential security threat based on the augmented data.

In some embodiments the method further includes deriving at least one rule from the received information and applying the received information includes applying the at least one derived rule to the received data, and the at least one action is prescribed by the at least one derived rule.

In some embodiments the method further includes receiving input enabling or disabling the at least one derived rule.

In some embodiments the method further includes evaluating the at least one derived rule to identify potential collisions with important events; and reconciling the collisions to create an improved rule.

In some embodiments augmenting the received data includes associating the received data with at least one category.

In some embodiments the at least one action is routing the augmented data based on the at least one category.

In some embodiments the at least one action is storing the augmented data for later review.

In some embodiments the at least one action is retrieving historical security events from a data storage system and forwarding the retrieved events to facilitate further investigation.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified:

FIG. 1 presents a flowchart of an exemplary method of processing security events;

FIG. 2 illustrates a machine learning module; and

FIG. 3 is a block diagram of an embodiment of an apparatus for processing security events.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

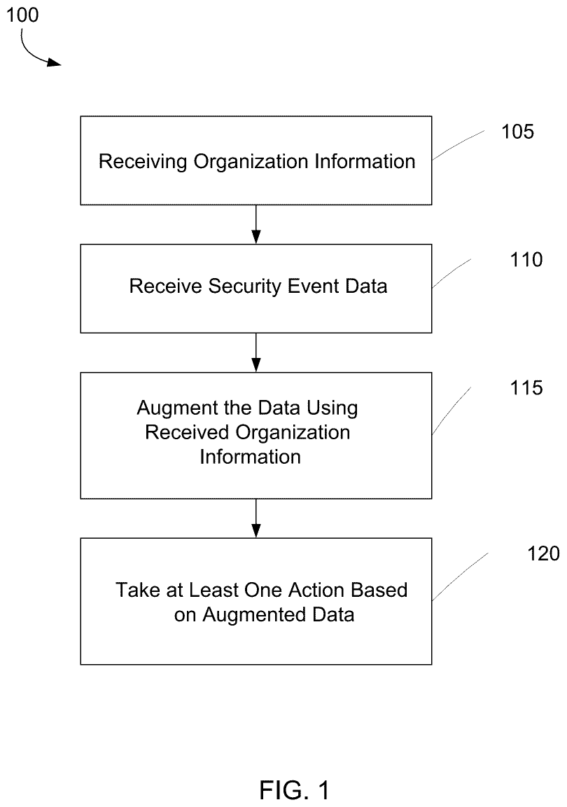

Referring now to FIG. 1, a flowchart of a method 100 for processing security events in a data fabric is shown. Information is received at a computing device from at least one organizational data source (Step 105). The computing device subsequently receives security event data (Step 110). The computing device augments the received security data by applying the received information to the received data (Step 115). The computing device takes at least one action based on the augmented data (Step 120).

Generally speaking, organizational data sources concern an organization's institutional, operational, and business knowledge. Exemplary organizational data sources include, but are not limited to, customer specified files, human resource software, employee training software, employee calendars, identity providers, asset inventory software, compliance software, and/or other sources. The information retrieved from the organizational data source(s) include, but is not limited to, employee's identity, employment status, work status (e.g., in office, on a business trip, on leave), employee's normal business hours, employee's normal location and/or jurisdiction, employee's position, employee's title, employee's accessible data, types and/or functions of related entities, customer contract information, customer jurisdiction, and/or other data, such as contextual information and/or relevant event fields.

Security related organizational data sources include, but are not limited to, which events and/or alerts are investigated by a security team and thereby define a specific company's workflow, investigation playbooks, and/or security concerns. For instance, related events and/or alerts from an initial event and/or alert may be identified in a database or other data source by the computing unit, including past security policy violations by particular employees or the organization as a whole (e.g., clicking phishing email links or downloading malware). The computing unit may perform one or more ad hoc queries to determine which events and/or alerts are related to an initial event and/or alert. Ad hoc queries may include questions or requests for a database that may not be included in a stored procedure and not parameterized or otherwise prepared. For instance, computing unit may generate one or more ad hoc queries in a data lake or other database associated with the received security event data. In some embodiments, the computing unit may utilize a clustering model and/or algorithm that may categorize and/or classify events and/or alerts to a group to create a rule or a machine learning model for use in augmenting the received security event data. The computing unit may identify events and/or alerts that may be related to an initial event and/or alert based on a similarity of data between events and/or alerts, similarity of contextual and/or relevant data field information, and/or other similarities. The computing unit may also create rules and/or machine learning models based on company specific workflows of investigation processes in cybersecurity to learn, e.g., what security events are high level, what security events can be ignored, typical questions and/or answers communicated during an investigation process, and/or other workflows.

Other security related organizational data sources include written instructions, alerts and queries included within programmatic scripts, alerts and queries saved within a security product, and natural language queries that can be transformed into ad hoc data queries using, e.g., trained large language models, and processed as described above.

Other organizational data sources may contain Governance Risk and Compliance (GRC) policies and/or other applicable regulatory requirements, relevant information regarding roles, responsibilities, deadlines, and/or other information pertaining to disclosure commitments. By deriving rules and/or machine learning models from this information, the computing unit may take post-augmentation action in response to one or more security events to ensure compliance with external legal requirements as well as internal processes established to meet those requirements.

Information from organizational data sources can be manually or automatically added to the system through a variety of means known to one of ordinary skill, such as file-level access, connector access, API access, uploads, etc. (Step 105)

The security event data may be any type of data received in any form, without limitation. Security event data may be received in the form of log files, data forwarded from an on-premises or cloud-based collector, data pushed to the data fabric and read via an application programming interface (API) call, and data pulled into the data fabric via an API call. (Step 110)

The computing device may augment the received security data by categorizing the data to a security threat category (Step 115). This may be done using, e.g., a machine learning model trained with data to associated the received security data to one or more categories, such as potential security threats, non-security related data, and/or other categories. Training data may be received through user input, external computing devices, and/or previous iterations of processing.

The computing device may augment the received security data by applying one or more rules to the received security data (Step 115). The rules may specify one or more regular expressions, thresholds, parameters, or other metrics that may determine if the received security data should be categorized to a particular security threat category or if another action should be taken in addition to or in lieu of categorization. The thresholds, parameters, and/or other metrics may be specified by user input and/or determined by the computing device based on information received from an organizational data source.

Exemplary conditions that may be the subject of rules include, but are not limited to, online resources being accessed from an unexpected user, application, or location, data files being copied to removable media, employees in process of leaving the company, and/or other contexts. One general form for conditional rules is the IF/THEN construction, e.g., if (event & metadata-tags match a set of conditions) then (take one of the processing actions). One such rule of that form is: if ((“event” matches writing a file to removable media, network drives, emails) and (metadata-tags do not include “employee who has given notice”)) then (filter the event). In this example, where a company could be concerned with data theft, the rule has the effect of not logging (i.e. filter) data being copied to removable media and the associated user is not leaving the company.

The applied rules may specify the augmentation of the security event data with one or more metadata-tags. For example, added metadata-tags may be based on non-security related data received from at least one organizational data source.

The computing device may augment the received security data by applying one or more machine learning models to the received security event data (Step 115). One possible augmentation is the classification of the received security event data to a perceived threat level. Levels may include, but are not limited to, low security threat, medium security threat, and/or high security threats. A threat detection machine learning model may be trained with training data correlating data and/or non-security related data to one or more threat levels. Training data may be received through user input, external computing devices, and/or previous iterations of processing.

The rules and/or machine learning models may be derived by the computing device from clusters and/or aggregates of events and/or alerts that are identified as being important. Important events and/or alerts may include, but are not limited to, malware detection, phishing events, or other events. The computing device may determine the importance of security events using a threat detection machine learning model as described above. For instance, a security event may initially be flagged as having low importance and stored in a data lake for future reference. The computing device may determine that future events similar to that low importance event are also low importance using a threat detection machine learning model. By contrast, the computing device may identify telemetry and patterns of security event data that may be of interest to a specific company using a threat detection machine learning model.

The rules and/or machine learning models derived by the computing device may be enabled or disabled by an operator on a per-rule/per-model basis. This allows for the specification of regimes where, e.g., anything that does not meet an enabled rule or model is filtered or routed to low-priority storage.

Rules, machine learning models, and other schemes for specifying the augmentation of received security event data may be directly or indirectly created by the customer as described above, but they may also be supplied by a third party, such as a community of users, the fabric vendor, etc. Some third-party schemes include reputation scores and whitelists/blacklists.

As part of the augmentation process, the computing device may extract one or more relevant event fields from the received security event data, such as, but not limited to, user id, device id, event source/type, severity level, event code, and/or other event fields. Once extracted, the computing device may apply a rule or machine learning model to one or more extracted fields and take one or more actions, such as adding a metadata-tag or issuing an alert. As an example, a rule requiring the generation of an alert may be triggered upon the receipt of security event data including fields specifying that a user that belongs to a Finance Department or has given notice.

One or more actions may be taken based on the augmented data (Step 120). For example, a rule applied to augment the data may also specify that a security alert should be generated after augmentation, or that the augmented data including any metadata-tags should be directed to one or more computing devices. Other exemplary rules include the retrieval and transmission of received organizational data information relevant to the security event. Embodiments using a machine learning model to augment the received security event data may also specify post-augmentation actions, such as alert generation. These activities may also vary according to the augmented threat level. For example, instance an alert concerning a low-level threat may be sent to a data lake for future evaluation while an alert concerning a high-level threat may be sent directly to a cybersecurity expert.

Other post-augmentation actions include the full or selective transmission of security event data and/or alerts to a data pipeline. These transmissions may be done on a per event/alert basis, e.g., with some data and/or alerts dropped entirely, some data and/or alerts sent to a data lake, and/or other data and/or alerts sent in various forms to both a data lake as well as a security information and event management (SIEM) system. In some embodiments, customer defined metadata-tags may be stripped from an event on a per destination basis, which may prevent potentially confidential information from being leaked to a third party.

Still other post-augmentation actions include enriching, filtering, data field reduction, data field masking, data field redacting, data reformatting, AI related processing (e.g., machine learning), API invocation, monitoring, evaluating, alerting, prioritizing and routing security event data and alerts within a data fabric, and the performance of queries against data sources to retrieve additional security event data for further processing as described herein (Step 120).

In some embodiments, post-augmentation actions may be taken based on a comparison of received security event data against non-security related data using a machine learning model, derived rule, etc. For instance, and without limitation, based on non-security related data, the computing unit may determine additional potential security threats such as a user's account being hacked, suspicious email communications, abnormal access to external websites, and/or other potential security threats.

In some embodiments, the computing unit may provide a real-time view of security event data traffic, security event data traffic trends, post-augmentation actions (including specific alerts), confirmed security incidents, action times, deliverables, deadlines, and/or metrics that may be useful to cybersecurity personnel (Step 120).

In some embodiments, the computing unit may provide answers to one or more user questions about security event data and/or post-augmentation actions through textual communication, such as through a graphical user interface (GUI). The computing unit may utilize a language processing model, such as a natural language processing model (NPL) to map textual questions into multiple ad hoc data queries and provide a textual response to a question

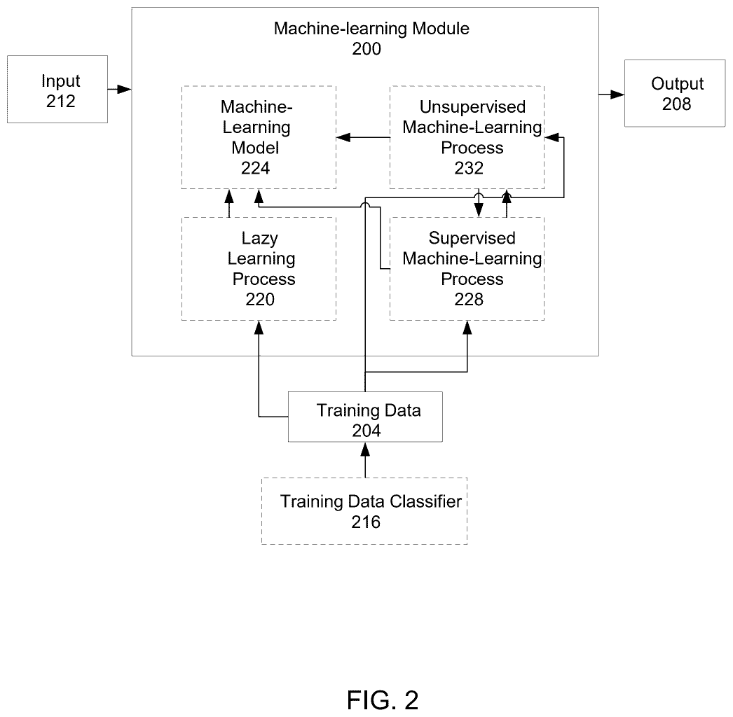

Referring to FIG. 2, an exemplary machine-learning module 200 may perform machine-learning process(es) and may be configured to perform various determinations, calculations, processes and the like as described in this disclosure using a machine-learning process. Machine learning module 200 may utilize training data 204. For instance, and without limitation, training data 204 may include a plurality of data entries, each entry representing a set of data elements that were recorded, received, and/or generated together. Training data 204 may include data elements that may be correlated by shared existence in a given data entry, by proximity in a given data entry, or the like. Multiple data entries in training data 204 may demonstrate one or more trends in correlations between categories of data elements. For instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations. Correlations may indicate causative and/or predictive links between categories of data elements, which may be modeled as relationships such as mathematical relationships by machine-learning processes as described in further detail below. Training data 204 may be formatted and/or organized by categories of data elements. Training data 204 may, for instance, be organized by associating data elements with one or more descriptors corresponding to categories of data elements. As a non-limiting example, training data 204 may include data entered in standardized forms by one or more individuals, such that entry of a given data element in a given field in a form may be mapped to one or more descriptors of categories. Elements in training data 204 may be linked to descriptors of categories by tags, tokens, or other data elements. Training data 204 may be provided in fixed-length formats, formats linking positions of data to categories such as comma-separated value (CSV) formats and/or self-describing formats. Self-describing formats may include, without limitation, extensible markup language (XML), JavaScript Object Notation (JSON), or the like, which may enable processes or devices to detect categories of data.

With continued reference to refer to FIG. 2, training data 204 may include one or more elements that are not categorized. Uncategorized data of training data 204 may include data that may not be formatted or containing descriptors for some elements of data. In some embodiments, machine-learning algorithms and/or other processes may sort training data 204 according to one or more categorizations. Machine-learning algorithms may sort training data 204 using, for instance, natural language processing algorithms, tokenization, detection of correlated values in raw data and the like. In some embodiments, categories of training data 204 may be generated using correlation and/or other processing algorithms. As a non-limiting example, in a body of text, phrases making up a number “n” of compound words, such as nouns modified by other nouns, may be identified according to a statistically significant prevalence of n-grams containing such words in a particular order. For instance, an n-gram may be categorized as an element of language such as a “word” to be tracked similarly to single words, which may generate a new category as a result of statistical analysis. In a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure, without limitation.

Further referring to FIG. 2, training data 204 may be filtered, sorted, and/or selected using one or more supervised and/or unsupervised machine-learning processes and/or models as described in further detail below. In some embodiments, training data 204 may be classified using training data classifier 216. Training data classifier 216 may include a classifier. A “classifier” as used in this disclosure is a machine-learning model that sorts inputs into one or more categories. Training data classifier 216 may utilize a mathematical model, neural net, or program generated by a machine learning algorithm. A machine learning algorithm of training data classifier 216 may include a classification algorithm. A “classification algorithm” as used in this disclosure is one or more computer processes that generate a classifier from training data. A classification algorithm may sort inputs into categories and/or bins of data. A classification algorithm may output categories of data and/or labels associated with the data. A classifier may be configured to output a datum that labels or otherwise identifies a set of data that may be clustered together. Machine-learning module 200 may generate a classifier, such as training data classifier 216 using a classification algorithm. Classification may be performed using, without limitation, linear classifiers such as without limitation logistic regression and/or naive Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of image data to facial or brain structures.

Still referring to FIG. 2, machine-learning module 200 may be configured to perform a lazy-learning process 220 which may include a “lazy loading” or “call-when-needed” process and/or protocol. A “lazy-learning process” may include a process in which machine learning is performed upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Still referring to FIG. 2, machine-learning processes as described in this disclosure may be used to generate machine-learning models 224. A “machine-learning model” as used in this disclosure is a mathematical and/or algorithmic representation of a relationship between inputs and outputs, as generated using any machine-learning process including without limitation any process as described above, and stored in memory. For instance, an input may be sent to machine-learning model 224, which once created, may generate an output as a function of a relationship that was derived. For instance, and without limitation, a linear regression model, generated using a linear regression algorithm, may compute a linear combination of input data using coefficients derived during machine-learning processes to calculate an output. As a further non-limiting example, machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include supervised machine-learning process 228. A “supervised machine learning process” as used in this disclosure is one or more algorithms that receive labelled input data and generate outputs according to the labelled input data. For instance, supervised machine learning process 228 may include body and/or face scans as described above as inputs, neural registrations as outputs, and a scoring function representing a desired form of relationship to be detected between inputs and outputs. A scoring function may maximize a probability that a given input and/or combination of elements inputs is associated with a given output to minimize a probability that a given input is not associated with a given output. A scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include unsupervised machine-learning processes 232. An “unsupervised machine-learning process” as used in this disclosure is a process that calculates relationships in one or more datasets without labelled training data. Unsupervised machine-learning process 232 may be free to discover any structure, relationship, and/or correlation provided in training data 204. Unsupervised machine-learning process 232 may not require a response variable. Unsupervised machine-learning process 232 may calculate patterns, inferences, correlations, and the like between two or more variables of training data 204. In some embodiments, unsupervised machine-learning process 232 may determine a degree of correlation between two or more elements of training data 204.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm). Coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of I divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

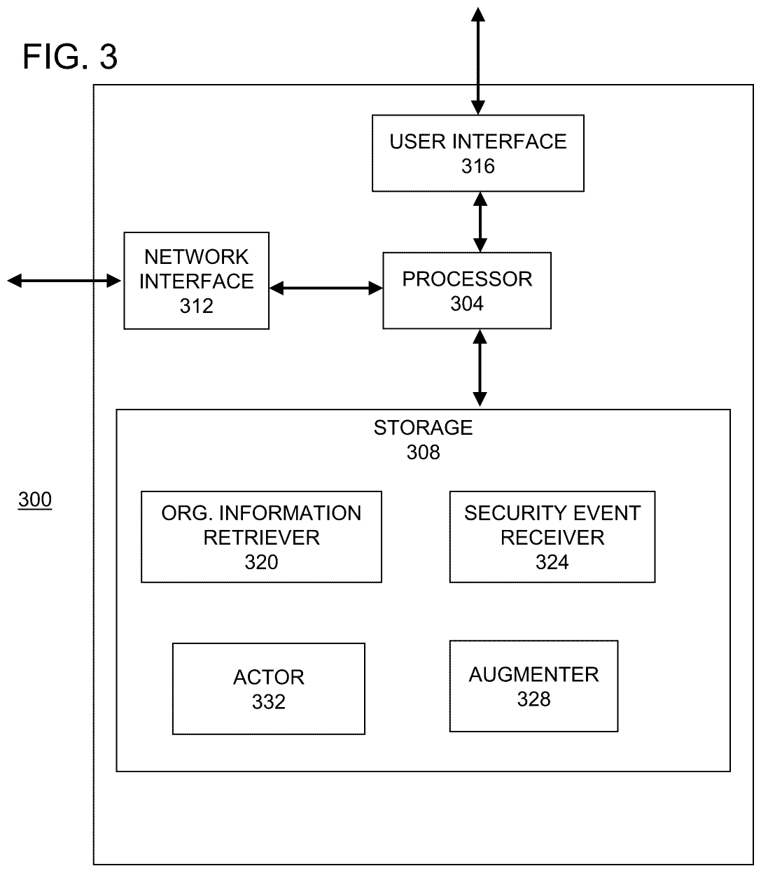

FIG. 3 is a block diagram of an exemplary apparatus 300 suitable for implementing the method of FIG. 1. The apparatus 300 may take the form of a physical server or a virtual, cloud-based computer.

The apparatus 300 includes a processor 304. The apparatus 300 also includes a storage 308 coupled to the processor 304. The storage 308 comprises a set of program instructions in the form of a plurality of subsystems, configured to be executed by the processor 304.

The processor(s) 304, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof. In one embodiment, processor 304 is an Intel Xeon or AMD Epyc server processor with at least 8 cores, clocked at least 1.5 GHz, and having an L2 cache exceeding 1 MB.

Computer memory elements implementing the storage 308 may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable programs stored on any of the above-mentioned storage media may be executable by the processor(s) 304.

The program instructions may be deployed via Docker, which has several advantages including a wide basis of support, traceability with precise version control and provenance, security, and ease of software installation.

The network interface 312 provides connectivity to other assets on a computer network, such as various data sources, network appliances, and operators as described above. The network interface 312 can be used to retrieve organizational information and receive data comprising one or more security events.

The user interface 316 can receive input from a user to control the operation of the system and display output related to that operation as well as images, reports, and data.

Although FIG. 3 illustrates the apparatus 300 including a user interface 316, one skilled in the art would understand that the apparatus 300 can be connected to several user devices (not shown) located at different locations via the network interface 312 and thereby provide ad hoc operator access to the apparatus.

The storage 308 includes a plurality of subsystems stored in the form of executable programs which instructs the processor 304 to perform the method steps. The plurality of subsystems includes: an organizational information retriever 320, a security event receiver 324, an augmenter 328, and an actor 332.

The plurality of subsystems includes an organizational information retriever 320. The retriever 320 is capable of performing a variety of tasks with organizational data sources. For example, the retriever 320 may access a variety of organizational data sources to retrieve a variety of information concerning the organizations' institutional, operational, and business knowledge through a variety of mechanisms as discussed above.

The plurality of subsystems includes a security event receiver 324. The receiver 324 is capable of receiving data describing one or more security events from a variety of data sources as described above. In some embodiments, processor 104 may leverage a company's investigative workflow to identify alerts and/or events related to an alert.

The plurality of subsystems includes an augmenter 328. The augmenter 328 is capable of augmenting received security data by applying one or more rules to the received security data as described above. Processor 104 executing the augmenter 328 subsystem may selectively augment security events and/or alerts with meta tags generated using non-security related data. For example, processor 104 may categorize an event represented in the security data to a particular security threat category.

The plurality of subsystems includes an actor 332. The actor 332 is capable of taking one or more actions based on the augmented data as described above. The processor 104 executing the actor subsystem 332 may be configured to control traffic shaping, routing, and/or filtering decisions for events and/or alerts based at least in part on metadata-tags generated from non-security related data. The actor subsystem 332 may also generate one or more alerts

### Exemplary Embodiments

### Organization Specific Enrichment and Context for Data Processing

In one embodiment, an organization's unique institutional and business knowledge is used to provide enrichment and context for processing within a data fabric/pipeline.

A data fabric/pipeline capable of filtering (i.e. dropping) as well as transforming data has been configured to ingest event and alert telemetry from multiple data sources. Example methods of ingesting data include: reading log files that have been uploaded to a cloud workload (e.g., an AWS S3 bucket), receiving data forwarded to the fabric/pipeline from an on-premises or cloud-based log aggregator/collector/forwarder), reading data pushed to the fabric/pipeline via an API integration/call, pulling data into the fabric/pipeline via an API integration/call.

The data fabric/pipeline is also capable of forwarding data to zero or more destinations on a per event/alert basis. E.g., some data may be dropped entirely. Some data may only be sent to a data lake. Other data may be sent in various forms to both a data lake as well as a SIEM.

In one embodiment the following steps are performed:
1. Security related events/alerts from a source are ingested by the data pipeline.
2. Relevant event fields or values (e.g. user id, device id, event source/type, severity level, event code, etc.) are extracted from the event/alert and are evaluated against organization specific knowledge which results in augmenting the event/alert with “metadata-tags.” This enrichment could be applied via a variety of methods, such as implementing rules created by the customer, a community of users, provided by the fabric vendor, created by AI, etc. These metadata-tag rules may incorporate “private” non-security related information data when augmenting events/alerts for subsequent evaluation and processing within the data fabric/pipeline. E.g., if a user belongs to an organizational unit such as Finance or has “given notice.”
3. The data fabric/pipeline then evaluates each discrete event/alert along with any associated metadata-tags to determine how it should be further processed within the data fabric/pipeline and forwarded to zero or more destinations.

This processing may include, but is not limited to:
1. Filtering and routing decisions
2. Data field reduction
3. Data masking and redacting
4. Data reformatting
5. AI related processing (e.g. Machine Learning)
6. Enrichments based upon non-organizational/external knowledge (e.g. IOCs, Reputation scores, Whitelists/Blacklists, industry threat models, etc.)
7. API callouts for 3rd party enrichment and processing
8. Fabric generated alerts and notifications

This processing may be implemented by a series of rules (applied for a data source or destination) of the form:
if (“event/alert & metadata-tags” match a set of conditions)
   then (take one of the processing actions)

A simple example of this could involve an event/alert that potentially could be sent to a SIEM product. A ruleset might include the following rule:
if ((“event” matches writing a file to removable media, network drives, emails) and
   (metadata-tags do not include “employees who have given notice))
      then (“filter or drop” the event/alert)

Normally an organization may want to filter (i.e. not forward) these events/alerts to their SIEM, unless the organization knows an employee is leaving. In this case, the customer may be concerned with data loss or exfiltration by a soon-to-be ex-employee.

It should be noted that there are other ways to craft, structure, prioritize, and specify precedence for rules and regular expressions to achieve these goals that are obvious to one skilled in the art.

Finally, these metadata-tags representing organizational knowledge may be (optionally) permanently attached to an event/alert on a per destination basis. This provides a “record in time” of additional organizational knowledge and context for an event/alert to an analyst or investigator at any arbitrary time in the present or future. Preserving a metadata-tag may be appropriate for events/alerts being forwarded to an internal SIEM, data lake, or security archive. This is to facilitate and speed up a company's alert triage and Incident Response workflow.

Metadata-tags (as well as other customer specified fields) may also be stripped from an event/alert on a per destination basis. This is to prevent potentially confidential information from being leaked to a third-party, such as an MSSP or MDR service.

### Operational Knowledge and Context Classification

In one embodiment, an organization's unique operation knowledge may be “learned”, and “interesting” or “important” security data may be identified and classified based upon usage, distinct work flows and “security playbooks.”

A “security playbook” is a documented set of strategies, methods, and procedures used by a security team when investigating and responding to different types of potential security threats or incidents. E.g. Portions of this could take the form of:
written instructions
alerts, searches/queries, etc. included within programmatic scripts
alerts, searches/queries, etc. saved within a security product (e.g. a SIEM)
ad hoc searches/queries, etc. performed within a security product (e.g. a SIEM)
NLP (Natural Language Processing) based queries leveraged to map textual questions into multiple ad hoc data queries and provide a textual response to a question.

Examples of how operational knowledge and use cases could be explicitly classified may include, but are not limited to:
Alerts—where pattern matches (e.g. such a RegEx) are applied to security data (either in real-time, as event streams, as batched jobs, post-processing, etc.) for the purpose of generating a notification/alert (e.g. within a SIEM), or automated response (e.g. within a SOAR).
Triage—searches/queries (e.g. based on text, keyword, RegEx, DB query, NLP based question, etc.) are applied to stored security for the purpose of determining the likelihood, severity, priority of a potential security incident.
IR (Incident Response)—searches/queries (e.g. based on text, keyword, RegEx, DB query, NLP based question, etc.) are applied to stored security for the purpose of determining the breadth, scope, details, and root cause of a security incident.
Forensic Investigation—similar in nature to an Incident Response workflow, but may encompass a significantly broader set of both historical security data and non-security data. E.g. A forensic investigation of a data breach could examine data from 12 months prior in an effort to identify the root cause and determine if any data was lost, what data was lost, who needs to be notified, etc.
Threat Hunting—ad hoc searches/queries (e.g. based on text, keyword, RegEx, DB query, NLP based question, etc.) are applied to stored security data for the purpose of discovering a potential security incident.

Additionally, after data has been explicitly classified, events/alerts could be classified for both matching or not matching explicit classifications. For example, if data does not match any workflow, classify it as “Not security relevant”

In another example, “Alert” or “Triage” data may be classified as “Interesting to SIEM.” Conversely, all other data (i.e. data that does not match the Alert of Triage workflow) may be classified as “Not interesting to SIEM.” This automated classification allows policy management to be greatly simplified. E.g. Expressed as a single checkbox to filter all data “Not interesting to SIEM” to the corresponding destination.

There are a variety of mechanisms for identifying pattern matches, searches, and queries supported by the products/tools used by an organization's security team, and based upon the use case classify the workflow.

E.g., in one use case within a SIEM, a customer may configure a SIEM alert that is triggered by matching a security event being ingested by the SIEM with a RegEx. Based on this use case, a customer could create a file containing a list of these Regular Expressions or potentially export this list directly from the SIEM itself. The file could be uploaded to the data fabric to provide context and help identify traffic that would be “interesting” or important to the organization's “Alerting workflow.”

E.g., in another use case within a SIEM, a customer may configure and save a set of searches/queries (e.g. based on text, keyword, RegEx, DB query, NLP based question, etc.) to be used in finding and retrieving relevant events from a database when triaging an alert. Based on this use case, a customer could create a file containing a list of these searches/queries or potentially export this list directly from the SIEM itself. The file could be uploaded to the data fabric to provide context and help identify traffic that would be “interesting” or important to the organization's “Triage workflow.”

E.g., in another use case within a Data Lake or SIEM, a customer may configure and save a set of searches/queries (e.g. based on text, keyword, RegEx, DB query, NLP based question, etc.) to be used in finding and retrieving relevant events from a database or archive when conducting an IR investigation. Based on this use case, a customer could create a file containing a list of these searches/queries or potentially export this list directly from the Data Lake, SIEM, scripts, etc. The file could be uploaded to the data fabric to provide context and help identify traffic that would be “interesting” or important to the organization's “Incident Response workflow.”

E.g., in another use case within a Data Lake or SIEM, a customer may perform a series of ad hoc searches/queries (e.g. based on text, keyword, RegEx, DB query, NLP based question, etc.) to be used in finding and retrieving relevant events from a database or archive when conducting an IR investigation or performing Threat Hunting. In the case where a Data Lake, SIEM, or some similar product supports auditing and recording the searches/queries, the records may be exported. The file could be uploaded to the data fabric to provide context and help identify traffic that would be potentially “interesting” or important to the organization's Triage, IR or Threat Hunting workflows. Ad hoc queries related (either by attribute or temporally) to Triage or IR related searches/queries may be associated with the corresponding workflow. Ad hoc queries unrelated to these workflows may be associated with Threat Hunting.

For a given workflow, AJ may be applied to potentially generalize related ad hoc searches/queries to determine the commonality and frequency of use, and if the associated data is generally considered to be “interesting” or “important.” Machine Learning may be applied to these queries to learn a customer's investigative methodology, enhance and maintain a customer specific playbook. I.e., learn what they typically ask about and incorporate that into the automated investigative process.

The pattern matches, searches/queries, and associated workflows enable the data fabric to identify which events being processed are “interesting” or “important” and in what context. Internally, these may be represented as a set of detection rules that apply appropriate metadata-tags to identify and classify “interesting” or “important” events/alerts.

### Operational Context for Policy Recommendations

In one embodiment, an organization's unique operation knowledge may be used in providing policy recommendations for determining how traffic should be processed within a data fabric/pipeline. Conceptually, a policy to control processing is implemented by one or more sets of “rules” where, if <some condition is met> then <an action> takes place.

The first step is to identify data that is “interesting” or “important” to an organization's security team, which possesses operational knowledge of an organization's security program, related controls, detections, and the team's associated workflows.

The second step involves the creation or selection of one or more “proposed rules.”

A variety of methods may be used in creating or selecting rules including, but not limited to:
Manually configured by a security practitioner
Provided from the Data Fabric vendor
Provided from a community of users
Provided from an MSSP, MDR, or another security service/product
Based upon security best practices
Generated via AI (Artificial Intelligence)

In one embodiment, “proposed rules” are partially generated through Artificial Intelligence, described as follows:

One of the potential operations that may occur as part of the data fabric/pipeline processing function is to send a copy of relevant data to an AI processing engine. It should be obvious to one skilled in the art that other mechanisms of providing the same event/alert telemetry to an AI processing engine (e.g. test data provided out-of-band, etc.) may implement the same methods and achieve the same results.

In some use cases (e.g. for filter/drop rules), an optional step which may improve efficiency, is to filter out data being sent to the AI processing engine that is considered operationally “interesting” or “important” (as the filter/drop use case does not apply). In other words, only send data that is classified by the user as “Not interesting to SIEM” to the AI processing engine as candidate data for generating filter/drop rules.

A variety of techniques may be implemented within the AI engine including, but not limited to, various Machine Learning algorithms, statistical metrics and classification, Clustering, etc. These methods potentially leverage well-known attributes.

Examples of well-known attributes include, but are not limited to:
Product type
Log type
Severity level
Event code
Event operations/flags
Machine name
User name
Application name
Process name and command line
Script name and command line
Binary hash of application, process, script, DLL, library, etc.
File names
Registry Key/Value names
Network ports
Network addresses
Domain names

The goal is to identify relatively large (by event/alert count and/or associated data volume) groups or clusters of “similar” events.

This provides an understanding as to the shape and volume of data traffic as it flows through the fabric/pipeline. Additionally, these clusters represent the largest potential opportunities for filtering event/alert traffic and reducing the volume and associated costs of unnecessary data being sent to a given destination.

Once data has been clustered, relevant attributes of the events/alerts are generalized into Regular Expressions which may serve as a test or pattern match to be used as conditions in the “proposed rules.”

The first two steps are independent and may be performed in either order.

The next step is to evaluate the “proposed rules” in a “monitor only” mode against relevant security data/telemetry and identify events/alerts that are considered “interesting” or “important” to the security team that match a “proposed rule.” This applies to any “proposed rule” (e.g. Manually configured, AI generated, etc.) The intent is to identify collisions where a “proposed rule” could potentially adversely filter/drop/transform an “interesting” or “important” event/alert.

An example implementation of this would be to detect any event/alert matching a proposed filter/drop rule, which has a metadata-tag “interesting” (or “important”, “alert”, “triage”, “IR”, etc.).

The final step is to reconcile collisions and provide additional recommendations on creating an optimal rule-set. This could be accomplished in a variety of ways, e.g. by creating exceptions within a proposed rule or creating a higher priority rule to explicitly allow traffic forwarded and not dropped.

The result is that identifying significant operational alerts, in conjunction with events/alerts that are explicitly identified as being important (e.g. malware detection, phishing alert), allows the system to identify important events/alerts the organizations chooses to investigate, and conversely identify less/non-important events/alerts to not investigate. This lower tier of non-important events/alerts may be filtered, depending upon the destination. E.g., these events may be forwarded to a data lake for retention and reporting, but not forwarded to a SIEM. This meets compliance and investigation needs, while reducing the volume of alerts that must be addressed by security professionals (i.e. reducing “alert fatigue”). The goal is to maintain operational integrity and while achieving maximum volume reduction and cost savings.

### Operation Context for Automating Incident Response Workflow

In one embodiment, an organization's specific institutional, operational, and business knowledge may be applied to events/alerts providing context when investigating a security incident.

A Triage workflow is a process applied to initially assess, prioritize and respond to security events/alerts. In practice, in addition to analyzing the event/alert itself, the security team spends a significant amount of time gathering non-security related information to assess the severity and scope of a potential incident. Since access to this type of data is restricted, the security team must involve personnel from other groups within the organization to provide this information, which may take significant time and delay the investigation, response time, and remediation of an incident.

By directly integrating or uploading files exported from non-security related systems (e.g. HRMS software, calendar system, etc.), the data fabric will have access to information that is typically not available to the security team. By applying metadata-tags to events/alerts as they are processed within the data fabric, the security team will have limited access to semi-anonymized or redacted data.

Examples of this could be something as simple as identifying what group an employee belongs to based upon an organizational chart (e.g. the user is on Finance), or if a user is travelling to another business location on company business (e.g. the user is detected San Francisco instead their home office in Boston). This meta-data provides potentially actionable data which can dramatically speed up the response time in triaging an incident.

Security incidents are often tracked within a system of record, e.g. with a unique case number within a ticketing system. Information such as event/alert samples, detection rules, and root cause analysis may all be included in the ticket. This information may be extracted via AI (e.g. NLP). The underlying events/alerts may be retrieved from a storage medium (e.g. a data lake, archive, SIEM, etc.) along with any associated events/alerts and used to identify potentially new types of events/alerts that would be considered “interesting” or important to the security team.

In another aspect additional searches/queries may be automatically generated and fetched from long-term, low-cost storage. E.g. The Data Fabric may typically only forward events to a SIEM that potentially match an organization's Alert workflow. All other events are forwarded to a data lake or archive. This dramatically reduces the volume of events/alerts sent to the SIEM. When an event/alert is detected that potentially matches an organization's Alert workflow, the data fabric may temporarily forward selected events/alerts that potentially match an organization's Triage or IR workflow. Additionally, a data lake or archive could be queried to read in previous events that potentially match an organization's Triage or IR workflow and automatically forward those events to the SIEM. Essentially this is leveraging operational knowledge in pre-fetching data from storage in anticipation of an IR investigation.

Additionally, depending upon “best practices” and the likely threat model, additional queries may be automatically generated to provide the answers to questions that a customer might not know to ask. Essentially providing a bootstrap playbook on initiating an investigation.

One example of this could be something as simple as identifying the affected user, their role, their current work status and what type of confidential information is available to them. Another might involve scanning a compromised email folder and identifying potentially exposed customer data (based upon email address), their associated jurisdiction and by extension relevant regulatory controls.

### Operation Context for Automating Compliance Workflow

In one embodiment, an organization's institutional, operational, and business knowledge encompass their unique Governance Risk and Compliance (GRC) policies.

Given a company's regulatory requirements (based upon business, types of customer data and legal jurisdiction) the system may extract disclosure requirements (e.g. what must be disclosed, within a specified timeframe, and to whom).

Given a company's unique Governance Risk and Compliance (GRC) policies, extract breach/incident management roles, responsibilities and contractual notification commitments.

Provide a management view of security incidents being tracked by the organization (e.g. via a ticketing system), applying corporate policies to what is known about each incident.

Provided a company's unique Governance Risk and Compliance (GRC) policies, as well as applicable regulatory requirements, extract relevant information regarding roles, responsibilities, deadlines, and information pertaining to disclosure commitments. This business specific workflow is mapped onto security incidents being tracked by the organization (e.g. via a ticketing system), providing a real-time view of the state of all potential or confirmed security incidents being investigated, including action items, deliverables, and deadlines.

### Advantages

In light of the foregoing disclosure, it will be apparent to one of ordinary skill that embodiments offer several advantages relative to the current stage of the art, including but not limited to:
Classifying events/alerts based upon an organization's security process, use-cases, workflows, and procedures. E.g. Data may be classified as being related to (or important for) alerts, triage, incident response, forensics, threat hunting use-cases, etc. Data may also be classified based upon matching or not matching one or more of these use cases.
The mechanism for identifying how events could be matched, classified, alerted on, searched for or queried could be accomplished by a variety of methods. E.g. Tests manually specified by a security practitioner, derived from documented playbooks or incident tickets (e.g. via NLP processing to generate matching patterns or data queries), customer specified configurations that are extracted/exported from a 3rd party tool or the data fabrics itself (E.g. alerts and/or saved queries within a SIEM), audit logs/records of queries/searches that are extracted/exported from a 3rd party tool or the data fabric itself (e.g. a data lake, archive, or SIEM), monitoring ad hoc queries, etc.
Leveraging AI to generate programmatic tests and a set of data fabric rules to perform the data classification.
Selectively augmenting security events/alerts with customer or pre-defined metadata-tags based on an event/alert's classification.
Selectively augmenting security events/alerts with customer or pre-defined metadata-tags based on an organization's institutional, operational, and business knowledge, as well as non-security related data.
Processing and controlling traffic shaping, routing, filtering, and transforming decisions for events/alerts within a data pipeline, based on customer defined metadata-tags.
Trigger external workflows within the data fabric processing when specific events/alerts are detected. E.g. if an event appears to be classified as part of a SIEM's alert workflow, automatically query an archive or data lake, archive or database for data related to subsequent workflows, ingest the data into the data fabric for processing, including routing the traffic to the SIEM. This proactively provides additional information to the SIEM to conduct a triage or IR investigation on an “as needed” basis.
Apply a variety of AI techniques (e.g. leverage well-known attributes, statistical metrics, Machine Learning, clustering, etc.) to events/alerts so as to determine the volume, patterns, or shape of traffic processed within the data fabric. The system could then generate “proposed rules” for processing data on a per source or destination basis. E.g. This could be used to identify candidates of traffic patterns for filtering to reduce volume and associated destination costs.
A subcase of using AI to generate “proposed rules” for filtering traffic for a given source or destination where in the first step, data has been bifurcated into two datasets; “interesting” data (which matches a related workflow) and “uninteresting” data (which does not). AI would then be applied to the “uninteresting” dataset. This may allow for a more efficient and lower cost method of generating “proposed” filtering rules.
Provide policy recommendations within the data fabric based upon vetting “proposed rules' (whether generated by AI, manual configuration by a security practitioner, etc.) against how data has been classified for a given destination's desired workflow. E.g. Validate that a “proposed rule” does not filter/drop events being forwarded to a SIEM that are classified as being related to a SIEM's configured Alerts/Notification rules.
Leveraging a company's investigative workflow (e.g. via ticketing systems, ad hoc queries, etc.), to identify events/alerts (and related events) that are considered important to an organization. This identifies events that should not be filtered, and in turn helps identify “less interesting” events/alerts that may be selectively filtered. This can dramatically reduce the volume of events that create “alert fatigue”.
Applying relevant customer specific non-security related data to provide context when investigating a security incident. Types of contextual data may be the result of general threat modeling (e.g. looking for indicators of compromised credentials or a phishing attack).
Extracting relevant information regarding roles, responsibilities, deadlines, and information pertaining to disclosure commitments from a company's unique Governance Risk and Compliance (GRC) policies, as well as applicable regulatory requirements, and apply this to security incidents being investigated by the organization, providing a real-time view of the current state, to effectively manage all ongoing incidents.

### EQUIVALENTS

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

What is claimed is:

1. An apparatus for processing security events within a data fabric, the apparatus comprising:
a processor; and
a memory communicatively coupled to the processor, the memory containing instructions configuring the processor to:
receive information from at least one organizational data source;
receive data comprising a security event;
augment the received data by applying the received information to the received data; and
take at least one action based on the augmented data.

2. The apparatus of claim 1, wherein the received information is non-security information.

3. The apparatus of claim 1, wherein the at least one action is generating an alert of a potential security threat based on the augmented data.

4. The apparatus of claim 1, wherein the processor is further configured to derive at least one rule from the received information and wherein applying the received information comprises applying the at least one derived rule to the received data, and the at least one action is prescribed by the at least one derived rule.

5. The apparatus of claim 4, wherein the processor is further configured to receive input enabling or disabling the at least one derived rule.

6. The apparatus of claim 4, wherein the processor is further configured to evaluate the at least one derived rule to identify potential collisions with important events and reconcile the collisions to create an improved rule.

7. The apparatus of claim 1, wherein augmenting the received data comprises applying a machine learning model to the received data to associate the received data with at least one category.

8. The apparatus of claim 7, wherein the at least one action is routing the augmented data based on the at least one category.

9. The apparatus of claim 1, wherein the at least one action is storing the augmented data for later review.

10. The apparatus of claim 1, wherein the at least one action is retrieving historical security events from a data storage system and forwarding the retrieved events to facilitate further investigation.

11. A method of processing security events within a data fabric using a computing device, the method comprising:
receiving information at the computing device from at least one organizational data source;
receiving data comprising a security event at the computing device;
augmenting, by the computing device, the received data by applying the received information to the received data; and
taking at least one action based on the augmented data using the computing device.

12. The method of claim 11, wherein the received information is non-security information.

13. The method of claim 11, wherein the at least one action is generating an alert of a potential security threat based on the augmented data.

14. The method of claim 11, further comprising deriving at least one rule from the received information and wherein applying the received information comprises applying the at least one derived rule to the received data, and the at least one action is prescribed by the at least one derived rule.

15. The method of claim 14, further comprising receiving input enabling or disabling the at least one derived rule.

16. The method of claim 14, further comprising:
evaluating the at least one derived rule to identify potential collisions with important events; and
reconciling the collisions to create an improved rule.

17. The method of claim 11, wherein augmenting the received data comprises applying a machine learning model to the received data to associate the received data with at least one category.

18. The method of claim 17, wherein the at least one action is routing the augmented data based on the at least one category.

19. The method of claim 17, wherein the at least one action is storing the augmented data for later review.

20. The method of claim 11, wherein the at least one action is retrieving historical security events from a data storage system and forwarding the retrieved events to facilitate further investigation.
